(19) United States
(12) Patent Application Publication
(10) Pub. No.: US 2025/0384489 A1
(43) Pub. Date: Dec. 18, 2025

(54) Method and System for Data Analysis

(71) Applicant: Vigilant AI Inc., Ottawa (CA)

(72) Inventors: Daniel Willis, Smith Falls (CA); Helge Brueggemann, Vernon (CA); Mark Hedley, Dorset (CA); Ronnie Jensen, Kamloops (CA)

(21) Appl. No.: 19/029,501

(22) Filed: Jan. 17, 2025

Related U.S. Application Data
(60) Provisional application No. 63/548,566, filed on Feb. 1, 2024.

(51) Int. Cl. G06Q 40/04

(52) U.S. Cl. CPC G06Q 40/042

(57) ABSTRACT

A method is disclosed for analysing a data set to determine a first processes. Common elements within the data are identified and associated with the first processes. The common elements are mapped within the first processes to provide an estimated process flow for the first process. Another process is evaluated to determine an absence of one or more common elements common to the estimated process flow. A map is then provided of the process flow indicating events and documents forming the similar processes.

### FIELD OF THE INVENTION

The invention relates to data analysis and more particularly to automated process analysis.

### BACKGROUND

After much negotiating, an investor entered into a complex conditional contract with a small group of investors and a company in need of financing. The agreement included a list of conditions and the effects that each condition would have on different people and companies involved. For example, the company was to receive 10,000 dollars from each investor upon signing of the agreement. If the company showed specific and measurable progress as indicated in the agreement, each of the investors was to receive 50,000 dollars from the company.

All investments were to be executed by wire transfer with a confirmation email to the company. All payments were to be directly deposited into investor accounts. The investor listed the $50,000 potential payment as a deferred gain as advised by his accountant. In the following year the gain was written down because the company did not achieve the measurable progress. The company then declared bankruptcy.

Two years after the company's eventual bankruptcy, the IRS in reviewing the investments, audits the write down by the investor. The issue being raised is that there is no evidence that the second amount was not owed and paid by the company as required under the contract. There is no evidence that the measurable outcome was not achieved, which it was not, but the profit—the $50,000—is being deemed income to the investor because the investor cannot show proof that the deposit was never made. As is well known, proving a negative is very difficult.

The investor claims that the company's bankruptcy should be sufficient evidence that the measurable result was not achieved. “Not so fast!” says the IRS. The investor claims evidence of no deposit in their accounts in the US should suffice, again, the IRS objects; there is no clear evidence that the measurable result was not achieved in accordance with the investment terms and the company's books and executives are no longer available.

These types of interactions occur all the time in different fields and applications; proving a negative is hard and often circumstantial evidence is doubted; however, the facts do not change simply because there is no definitive document stating that the facts turned out a particular way. Often, even when there is a definitive document, it is unavailable or lost to the party who needs it; for example, who keeps a letter stating that they will not be paid. Here, the now bankrupt company had some document or data indicating that payment was not necessary, but the corporate data is no longer accessible.

It would be advantageous to provide an improved view of facts, events, communication, and results.

### SUMMARY OF EMBODIMENTS

In accordance with embodiments of the invention there is provided a method comprising: accessing a data element within a data store; determining for the data access a value for each of a plurality of metadata elements, the plurality of metadata elements having previously determined values stored in association with the data element; and storing the values for each of the plurality of metadata elements as metadata, in conjunction with the previously determined values stored in association with the data element.

In accordance with embodiments of the invention there is provided a method comprising: accessing a data element within a data store; determining for the data access a value for each of a plurality of data, the plurality of metadata elements having previously determined values stored in association with the data element, the determined value based on the data access and at least a previously determined value of the previously determined values; and storing the values for each of the plurality of metadata elements as metadata.

In some embodiments the metadata for being stored is determined based on previously determined metadata and wherein data relating to different metadata elements is stored at different times.

In some embodiments the metadata for being stored relates to same fixed metadata elements, data relating to each metadata element stored with each data element access forming a plurality of metadata instances for a same data element, each instance relating to a different data element access.

In accordance with embodiments of the invention there is provided a method comprising: storing metadata; accessing a data element within a data store, the data element having metadata stored in association therewith; determining a plurality of data relating to metadata elements relating to the data access; and storing the plurality of data as metadata in addition to the previous metadata associated with the data element.

In accordance with embodiments of the invention there is provided a method comprising: forming a predictive model based solely on metadata relating to one or more files.

In some embodiments the predictive model is based on metadata relating to at least two separate files.

In some embodiments the predictive model is based on metadata relating to at least two separate systems.

In some embodiments the predictive model is based on metadata relating to at least two separate applications.

In some embodiments the predictive model is formed absent accessing the first data.

In accordance with embodiments of the invention there is provided a method comprising: forming a predictive model based on data and metadata indicative of behaviours and activity relating to at least two applications.

In accordance with embodiments of the invention there is provided a method comprising: forming a predictive model based on data and metadata indicative of behaviours and activity relating to two different systems.

In accordance with embodiments of the invention there is provided a method comprising: storing first data within a first data store; storing within the first data store first metadata comprising a plurality of metadata elements in association with the first data; storing within the first data store second metadata comprising a plurality of metadata elements in association with data other than stored within the first data store; and in response to at least one of a data filtering and data search request, accessing the first metadata and the second metadata to process at least part of the at least one of a data filtering and data search request.

In accordance with embodiments of the invention there is provided a method comprising: storing first data within a first data store; storing within the first data store first metadata comprising a plurality of metadata elements in association with the first data; in response to at least one of a data filtering and data search request by a first process, requesting second metadata from a second data store, the second data store other than within control of the first process; receiving a subset of the second metadata from the second data store, the subset less than all of the second metadata and filtered by a second process based on an access privilege of the first process; and accessing the first metadata and the subset of the second metadata to process at least part of the at least one of a data filtering and data search request.

In accordance with embodiments of the invention there is provided a method comprising: storing first data within a first data store; and storing within the first data store first metadata comprising a plurality of metadata elements in association with the first data, some of the metadata elements comprising statistically calculated statistical values derived from one of the first data and the first metadata.

In accordance with embodiments of the invention there is provided a method comprising: storing first data within a first data store; and storing within the first data store first metadata comprising a plurality of metadata elements in association with the first data, some of the metadata elements indicating user behaviour when accessing the first data, the user behaviour comparing at least two separate events in time.

In some embodiments the plurality of metadata elements comprises data relating to file access times for different groups of users.

In some embodiments the plurality of metadata elements comprises data relating to file access times for each of a plurality of different groups of users.

In some embodiments the two separate events relate to a frequency of data access and wherein during a restore operation, files are restored in order of frequency of data access.

In accordance with embodiments of the invention there is provided a method comprising: storing first data within a first data store comprising at least an email file; storing first metadata comprising a plurality of metadata elements in association with the first data; and based upon the first metadata, organising display of the email data, the email data organised differently for different functions based on different portions of the first metadata.

In some embodiments email messages are displayed in an order indicating priority based on the first metadata.

In some embodiments the first metadata incorporates metadata relating to files within a datastore other than email files and attachments.

In some embodiments the email is displayed in threads associated with a transaction.

In accordance with embodiments of the invention there is provided a method comprising: providing a first metadata data set; providing a second other metadata data set; and using a correlation engine correlating the first metadata data set and the second metadata data set to produce a new metadata set incorporating data from each of the first metadata data set and the second other metadata data set.

In some embodiments the first metadata data set relates to first data and the second other metadata data set relates to second other data and where the correlation engine is provided access to the first data and the second other data in performing correlating.

In some embodiments the method comprises: using a correlation engine correlating the first metadata data set and the second metadata data set to produce a second new metadata set incorporating data from each of the first metadata set and the second other metadata data set, the second new metadata data set derived from the same first metadata data set and the same second other metadata data set as the new metadata data set and the second new metadata data set different from the new metadata data set.

In accordance with embodiments of the invention there is provided a method comprising: providing an external process with a metadata view of internal data, the metadata view different from a metadata view of an internal process.

In accordance with embodiments of the invention there is provided a method comprising: providing a spreadsheet including metadata therein within spreadsheet entries, the metadata for analysis and for linking to actual data outside the spreadsheet.

In accordance with embodiments of the invention there is provided a method comprising: storing first data within a first data store; storing within the first data store first metadata comprising a plurality of metadata elements in association with the first data; storing within the first metadata data relating to events, the events for use in at least one of punctuation of metadata analysis and labeling of data based on the events.

In some embodiments the events include executing a contract and completing the contract and wherein in listing documents, documents are grouped as occurring before executing the contract, during the contract, and after the contract is completed.

In some embodiments the first metadata is filterable to create a filtered snapshot of the first metadata, the filtered snapshot allowing analysis of the first data based on the filtered snapshot of the first metadata.

In some embodiments the filtering results in a temporal snapshot of the first metadata.

In accordance with embodiments of the invention there is provided a method comprising: storing first data within a data store; storing first metadata comprising a plurality of metadata elements in association with the first data; storing with the first metadata elements, metadata context data for determining at least one of relevance, transformation and filtering of data associated with the metadata elements; providing a first data view of the first data, the first data view comprising some of the first data being at least one of transformed, filtered, or selected based on the metadata context data; and providing a second data view of the first data, the second data view comprising some of the first data being at least one of transformed, filtered, or selected based on the metadata context data, the second data view different from the first data view.

In accordance with embodiments of the invention there is provided a method comprising: storing first data within a data store; storing first metadata comprising a plurality of metadata elements in association with the first data; predicting, based on the first metadata, a data element to be included in the first data approximately at a known time; and at the known time, verifying a presence of the predicted data element within the first data to when the data is other than present provide a reminder regarding an absence of the data.

In accordance with embodiments of the invention there is provided a method comprising: storing first data within a data store; storing first metadata comprising a plurality of metadata elements in association with the first data; predicting, based on the first metadata, a trend; and providing an indication of the trend.

In accordance with embodiments of the invention there is provided a method comprising: processing metadata in a recursive fashion wherein some metadata is processed on different systems and wherein metadata passed from one recursion to another differs depending on security and data sharing parameters of each system relative one to another.

In accordance with embodiments of the invention there is provided a method comprising: storing first data within a data store; storing first metadata comprising a plurality of metadata elements in association with the first data; using the first metadata for determining data and metadata segments for use with a first application; and using the first metadata for determining different data and metadata segments for use with a second other application.

In accordance with an embodiment there is provided a method comprising: providing a first process; providing first data; analysing the first data within a data store to map second data forming part of the first data to different instances of the first process; determining first differences between the different instances of the first process; proposing A/B tests, where some first processes are implemented according to Process A and some first processes are implemented according to Process B, Process B different from Process A, for determining which first difference is statistically controllable through varying the first process during execution between A and B, when a first difference is statistically controllable, selecting between A and B the process that is a statistically improved version of the first process; and storing the improved version of the first process as the improved first process.

In some embodiments, Process B is a process similar to Process A but absent a missing step.

Some embodiments comprise when a plurality of instances of Process B are detected, providing an indication to a user to add the missing step to a first group of processes comprising some of the plurality of instances of Process B and to not add the missing step to a second group of processes comprising others of the plurality of instances of Process B different from the instances in the first group; comparing an outcome of the first group and the second group; and when the outcome indicates a statistical likelihood that the missing step affects the outcome of the processes, providing an indication to the user of the statistical affect of the missing step.

Some embodiments comprise prioritising a first test between a first Process A and a first Process B over a second test between a second Process A and a second Process B.

In some embodiments when the first Process A and the first Process B achieve similar results, deprioritising the first test relative to the second test.

In accordance with an embodiment there is provided a method comprising: analysing at least a data set to extract therefrom data related to a first instance of a first process for achieving a first result; analysing the at least a data set to extract therefrom data related to a second instance of the first process for achieving the first result; determining common elements of the first instance of the first process and second instance of the first process; mapping the common elements within the first processes to provide an estimated common process flow including potential causal links; determining a potential causal link for exploration, the causal link related to elements within the first instance of the first process that are not common to elements within the second instance of the first process wherein the first instance and the second instance have statistically different results; performing a test to see if the potential causal link is statistically causal; and when causal, including the potential causal link within the process as a causal link.

In some embodiments determining that the first instance and the second instance have statistically different results is performed by performing a test of results achieved with the elements that are not common included in the first process compared to results achieved absent the elements relative to each other.

In accordance with an embodiment there is provided a method comprising: analysing at least a data set to extract therefrom data related to a first instance of a first process for achieving a first result; analysing the at least a data set to extract therefrom data related to a second instance of the first process for achieving the first result; determining common elements of the first instance of the first process and second instance of the first process; mapping the common elements within the first processes to provide an estimated common process flow including potential causal links; determining a potential causal link for exploration, the causal link related to a first element within the first instance of the first process that is not common to a second element within the second instance of the first process; and performing a test to see if the potential causal link is statistically causal of a difference in outcome between the first instance and the second instance by performing some processes with the first element and other first processes with the second element and comparing results obtained with the first element against results obtained with the second element; and when causal, including the potential causal link within the first process as a causal link with an indication of which of the first element and the second element is preferred.

In accordance with an embodiment there is provided a method comprising: providing a first process; providing first data within a first data store; analysing the first data within the data store to map second data forming part of the first data to a first instance of the first process and to map third data forming part of the first data to a second instance of the first process and determining first supradata based on the first process, the first data, the second data and the third data; based on the first supradata, predicting at least one of first process steps and first information that is potentially absent; and reporting the at least one of the first process steps and first information that is potentially absent to a user of the system.

Some embodiments comprise: providing new data within the first data store; extracting new supradata based on the new data within the first data store; based on the new supradata, predicting at least one of second process steps and second information that is potentially absent; and reporting the at least one of the second process steps and second information that is potentially absent to a user of the system.

In some embodiments the supradata and the new supradata is stored in a second data store different from the first data store and wherein extracting the new supradata is performed on data in transit.

In accordance with an embodiment there is provided a method comprising: providing a first process; providing first data in transit; analysing the first data to map second data forming part of the first data to a first instance of the first process and to map third data forming part of the first data to a second instance of the first process and determining first supradata based on the first process, the first data, the second data and the third data; storing the first supradata in a data store; based on the first supradata, predicting at least one of first process steps and first information that is potentially absent; and reporting the at least one of the first process steps and first information that is potentially absent to a user of the system.

In accordance with an embodiment there is provided a method comprising: analysing a data set to determine first processes reflected thereby; determining common elements within the first processes; mapping the common elements within the first processes to provide an estimated process flow; evaluating an identified process to determine an absence of one or more element common to the estimated process flow; and providing a notice of the absent element.

In accordance with an embodiment there is provided a method comprising: analysing a data set to determine first processes reflected thereby; determining common elements within the first processes; mapping the common elements within the first processes to provide an estimated process flow; evaluating an identified process to determine a location of a process within one or more process flows; and providing a reminder indication relating to an upcoming element within the one or more process flows.

In accordance with an embodiment there is provided a method comprising: analysing a data set to determine from a number of processes common elements forming part of a first processes; mapping the common elements within the number of processes to provide an estimated process flow; evaluating an identified process to determine an absence of one or more common elements common to the estimated process flow; and providing a map of the identified process flow relative to the estimated process flow and indicating events and documents forming the number of processes.

In accordance with an embodiment there is provided a method comprising: analysing a data set to determine common elements within similar processes, the common elements forming the similar processes; providing a map of the similar processes indicating events and documents forming the similar processes and highlighting at least one of an event and a document absent from at least one of the similar processes.

Some embodiments comprise analysing a data set to determine elements common to a first portion of each of a plurality of similar processes; and predicting a plurality of different potential upcoming elements based on following elements within each of the plurality of similar process, the following elements following the first portion.

Some embodiments comprise providing a suggested course of action for maintaining a predetermined plurality of similar processes.

In accordance with an embodiment there is provided a method comprising: analysing a data set to determine common elements within similar processes, the common elements forming the similar processes; providing a map of the similar processes indicating events and documents forming the similar processes; manually modifying the map of the similar processes to eliminate some common steps or documents within the similar processes; and storing data indicative of a modified process comprising an indication of events and documents forming the similar processes as edited.

In accordance with an embodiment there is provided a method comprising: analysing a data set to determine common elements within similar processes, the common elements forming the similar processes; providing a map of the similar processes in a form for training individuals in the process.

### BRIEF DESCRIPTION OF THE DRAWINGS

Exemplary embodiments of the invention will now be described in conjunction with the following drawings, wherein similar reference numerals denote similar elements throughout the several views, in which:

FIG. 1 illustrates a simplified example of direct association from prior art. FIG. 1, shown is a simplified flow diagram of the tax filing process.

FIG. 2 includes FIGS. 2A and 2B (Also referred to as FIG. 2) and is the similar method as that of FIG. 1, but entangled data captured in the repository and with a processor in execution of a first process for monitoring and predicting method status. FIG. 2A shows the first process for data entanglement analysis. FIG. 2B also shows a supradata repository for data entanglement analysis.

FIG. 3 is a simplified flow diagram of a method of monitoring entanglements in a sales cycle.

FIG. 4 includes FIGS. 4A and 4B (Also referred to as FIG. 4) and is an example of entanglement in inventories. FIG. 4A reflects a direct entanglement. FIG. 4B reflects a more complex indirect entanglement in manufacturing.

FIG. 5 is a complex communication system method for entanglement analytics.

FIG. 6 is a simplified sales process formalized and enhanced by quantum analytics.

FIG. 7 is a method of email communication evaluation for use in managing entangled messages.

### DETAILED DESCRIPTION OF EMBODIMENTS

The following description is presented to enable a person skilled in the art to make and use the invention and is provided in the context of a particular application and its requirements. Various modifications to the disclosed embodiments will be readily apparent to those skilled in the art, and the general principles defined herein may be applied to other embodiments and applications without departing from the scope of the invention. Thus, the present invention is not intended to be limited to the embodiments disclosed but is to be accorded the widest scope consistent with the principles and features disclosed herein.

### Definitions

Data Element: Data elements are meaningful segments of information logically identifiable but not necessarily constrained by a one-to-one relationship to a traditional file. A data element could be a file, but can also be a datum, a file segment, multiple files, multiple file segments, a grouping of files and file segments, etc. For example, an email archive file is a single file which may contain many data elements in the form of emails some of which in turn contain additional data elements. Where they are embedded within a file or container, a data element may also be referred to as a data field.

Data Entanglement: Data entanglement is a new term referencing the way in which two or more data elements are directly or indirectly related or associated to one another. With the knowledge of entanglement, understanding or observation of the state of one entangled data element enables a statistically relevant inference about and an understanding of the state(s) of its entangled pairings.

Data Uncertainty Principle: This principle is a reference to the degree of confidence to which data entanglement and/or inferences resulting from said data entanglement may be accurate. The data uncertainty principle reflects that data analytics includes confidence factors which are not absolute. As such observation of the original data element has limits on accuracy; there are corresponding limitations on the accuracy of the implications of its entangled pairings.

Entangled pairings: An entangled pairing refers to the two or more data elements that show data entanglement, also referred to as quantum data entanglement. Entangled pairings are not necessarily a simple one-to-one association, but for simplicity, data entanglement is referred to as a “pairing”. Typically, entangled pairings is a mutual alignment and association across a two or more data elements.

Entangled processes: Are business processes that each contain one or more entangled data pairings. With their data entangled there is a notable chance that the outcomes of the business processes are also entangled, where the outcome of one process can be used to infer or statistically predict one or more outcomes or aspects of outcomes from the entangled processes.

Modeled Business Process: Is a means of representing activities which are undertaken by an enterprise in their normal course of business operations. It includes a representation of a flow of a process, outlining each step taken in executing the process. A modeled business process includes a representation of the order of these steps, their dependencies, and their interrelationships. It also includes modeling and representation of the data associated with these steps. This includes, the data and documents created, consumed, referenced, updated, or destroyed for each step in the process or involved in the process overall. A completely modeled business process identifies and includes representation of the informational segments, data fields, within each of the documents associated with the business flow.

Supradata: supradata is a combination of at least some of metadata, context, actions, transformations, and relationship elements that are stored in a time varying fashion such that metadata is appended to previous metadata instead of overwriting same to form a present, historical, and continuously deepening metadata data set. In addition, supradata includes context regarding the data element. The context may give reference to the origins of the data, the purpose of the data, or the contents of the data. Some context also includes actions on, interactions with, and relationships with other data elements within a data set. By example, a PDF contract file may include a link to the email to which it was attached, which in turn contains a link to the email archive from which the email was extracted all within the current or some other external data set.

Quantum data analytics: the study, modelling, and analysis of entangled data elements, as well as insights that are achievable through said quantum data analysis. The learnings that are achievable through applied artificial intelligence (AI)/machine learning (ML) where the scope of data entanglement often exceeds human capacity for meaningful comprehension. The term “Quantum” applies as a parallel reference to quantum mechanics. Just as sub-atomic particles exist in different states based on which quantum shell or energy state they reside as influenced by other sub-atomic particles, so too does the data exist in differing states, which may be influenced by other data elements.

In Quantum mechanics, sub-atomic particles in close proximity or with common interactions can become associated with one another. They become entangled. Once entangled, observation of one such particle can be used to infer the state of the other, even when they are separated by distances too far to allow for the transmission or direct influence of state. Essentially, through entanglement they observationally share some relationship, some information. When entangled, observing one particle tells an observer something about the other particle. This is well studied. Although data analysis differs from sub-atomic particles, these same concepts can and do apply to data elements. An analogous concept to particle entanglement, entangled pairings, is now applied to information management.

It should be noted that the terms Quantum Data Analytics and Quantum Data Entanglement are coined to offer an associative parallel in understanding. There is no implication that the science and mathematics of Quantum Mechanics are applicable to the science and methodologies of their data management namesakes. Similarly, it is not inferred that observing one piece of data affects another, but instead that one piece of data is useful in prediction, analysis, and processing of another piece of data of an entangled pairing.

It must be recognized that, just as its namesake implies, quantum data entanglement can happen on many different levels. Associations may be direct, indirect, fuzzy, or dissociated. The measure of uncertainty of a particular association is its confidence factor.

Direct association is where a direct contiguous, possibly convoluted path can be established defining the relationship between data elements.

Indirect association is where the path is not obvious. An association may not be simple or contiguous, rather based on convoluted associations which offer for example parallel paths that are assumed to align and join to create consistent shared behaviors, a virtual path of association. The degree to which the virtual path of association is predicted to be trustworthy is reflected in its confidence factor. If the confidence factor is higher than an acceptable threshold for the analysis (for example, 70% or greater) then an indirect association is more reliable. If the confidence factor is lower than the threshold then it is not a pure indirect association and is less reliable for predictions.

Fuzzy association is a special case of indirect association where a path almost exists within the scope of acceptable confidence. However, to make a true connective path of association, a confidence factor outside acceptable levels must be allowed for one or more associations, a “fuzzy” path equals a “fuzzy” association. In such an instance the confidence factor being out of bounds for the path leg(s) which are fuzzy is essentially overridden and the virtual association path is accepted, statistically. However, even in the case of fuzzy association there are limits to how much risk of error is acceptable. For a given analysis, the lowest acceptable fuzzy limit is established. Similarly, the number of fuzzy associations required to achieve a valid virtual association can be limited. So long as the parameters stay in bounds, above the absolute lowest acceptable confidence and below the maximum number of fuzzy paths, then the fuzzy association is allowed. In some examples, a fuzzy path is defined as a series of paths with similar start and endpoints that combine to acceptable levels of confidence though no individual path achieves acceptable levels of confidence. Thus, the path itself is not known or understood but events at each end point, A and B, are associated with a fuzzy association.

Dissociated is where there is no discernible relationship within the scope of acceptable confidence, direct, indirect, or fuzzy. This does not preclude that a relationship does exist. the relationship may be too tenuous or apparently unreliable to accept as a statistical probability.

Quantum data entanglement and the resulting insights from quantum data analytics do have real world applications. As illustrated by the following embodiments and methodologies, quantum analytics achieves a benefit of offering a potentially more complete data model, hence a more complete picture of events and results.

In most cases through data entanglement, just the very existence of an entangled data element or a recent update to said data element is enough to yield insight with the entangled pairs. In this manner, processes are executed and managed more efficiently through supradata when forming part of an entangled pair. The supradata is associated with a data element within the data and, thus, the process does not require access to the actual data element itself—the data element need not be retrieved, opened, or read. This results in efficiencies across a wide swath of factors including but not limited to network bandwidth, managing secure access to file contents, process monitoring performance, costs for cloud storage and egress fees, and others.

In some information and communication processes, there are well known connections between information. These are direct associations. For example, submitting a tax-return results in a tax assessment being performed and a tax assessment report being transmitted to the tax filer. Thus, for every submitted return, there should be an assessment process and record, assessment results, and an assessment report. This is a well-documented business process. If a taxpayer submits a return and no report is received, this typically indicates that an error has occurred after submission. For example, the tax return was lost in the mail, the tax return was not sent and may be misplaced, perhaps under the taxpayer's car seat, the assessment process was not begun, the assessment process stopped accidentally, or the report was sent and never received. Other explanations are also possible, but there are finite reasonable explanations.

When a tax assessment report is not received by a taxpayer, they typically contact the IRS to ensure that their tax return was received by the authorities. They inform the authorities that the assessment report was not received, and the authorities then follow their internal process to correct the deficiency by either completing the assessment or by forwarding another copy thereof to the taxpayer. This too is a well-documented business process, albeit reliant upon the taxpayer initiating their own separate recovery process.

Thus, a first event of a taxpayer, filing a tax return, is linked to a second event for the tax payer, receiving a tax assessment report; the IRS process is immaterial to the tax-payer though it forms a part of the overall business process. A business process modeled for the tax payer is based on both documents and the actions taken for/with each. The creation and filing of the return by the taxpayer, a lapse of time, and a receipt of a tax assessment report. Review and creation of an assessment report by the tax authority and then mailing of said assessment report is either indicated as outside the taxpayer responsibilities or is simply hidden from the taxpayer. That said, each step in the process is modelable.

A model of these events, their documents, and their linkage, when created, is useful in identifying errors and omissions within a timeline.

In other examples, entangled data appears less related or connected. This is likely indirect association. For example, a company hires 3 new staff for each 1 percent improvement in sales. Here, an analysis shows that when sales-to-leads ratio increases, hiring increases. With additional hiring, the company needs additional space and additional equipment. Therefore, there is an entanglement between the sales to leads ratio and the issuance of Purchase Orders for computer equipment. In this case, the entanglement is a direct causal relationship. Thus, with improved sales to leads, the system anticipates a process for purchasing computer equipment, increasing space utilisation, and hiring staff.

Additional entanglements may also occur which are not necessarily so direct or obvious. For example, the additional staff parking spaces may require growth of the parking lot which cannot be achieved without a local re-zoning of the area which had previously been zoned light residential. If the sales to leads ratio increases and the other entangled processes are not commenced, then management needs notification as potentially, this could affect overall performance if there are not enough parking spaces so there are not enough staff to handle the increase, or their profitability drops when they get fined by the city for their expanded lot against zoning.

In another example, the local and only lunch restaurant has 22 seats. Growth in staff overwhelms the restaurant resulting in performance issues around lunchtime. With each additional hire, the performance issues are more noticeable. That said, the restaurant is completely outside the control of the business and data relating to the restaurant may be opaque to the business. The business just notices a productivity issue around lunchtime that grows more evident with each new hire.

Of course, by relying on automated analysis, entanglements are identifiable, some of which appear to have no logical connection. An increase in revenue for a large company might increase local housing costs. More noteworthy, a decrease in revenues for that same company might decrease local housing costs. A decrease in revenues for that same company might increase marriage troubles and thereby drive increased therapy spending or decreased performance per employee. These indirect associations may also meet the criteria for fuzzy associations. Certain processes are entangled with other processes that are seemingly distant therefrom and often difficult to logically predict, though often a logical explanation is available once the entanglement is noted or given enough of the available data.

Since many business processes are non-linear, an increase in sales to leads ratio might tax suppliers and lead to an increased lead time. The increased lead time might lead to a decrease in staff hiring (temporarily) as training and installation is spread out over a longer time-period. Then, once the supplier ramps up production, suddenly the same stimulus, an increase in sales to leads results in increased hiring, etc. because the supply chain issues abate. This exists in many supply-chain constricted situations. Thus, quantum data analytics and predictive insights may not only be non-linear in nature, but often require monitoring, feedback, and ongoing analysis to determine changes in causes and effects. What appears to be similar input data sometimes results in substantially different output data.

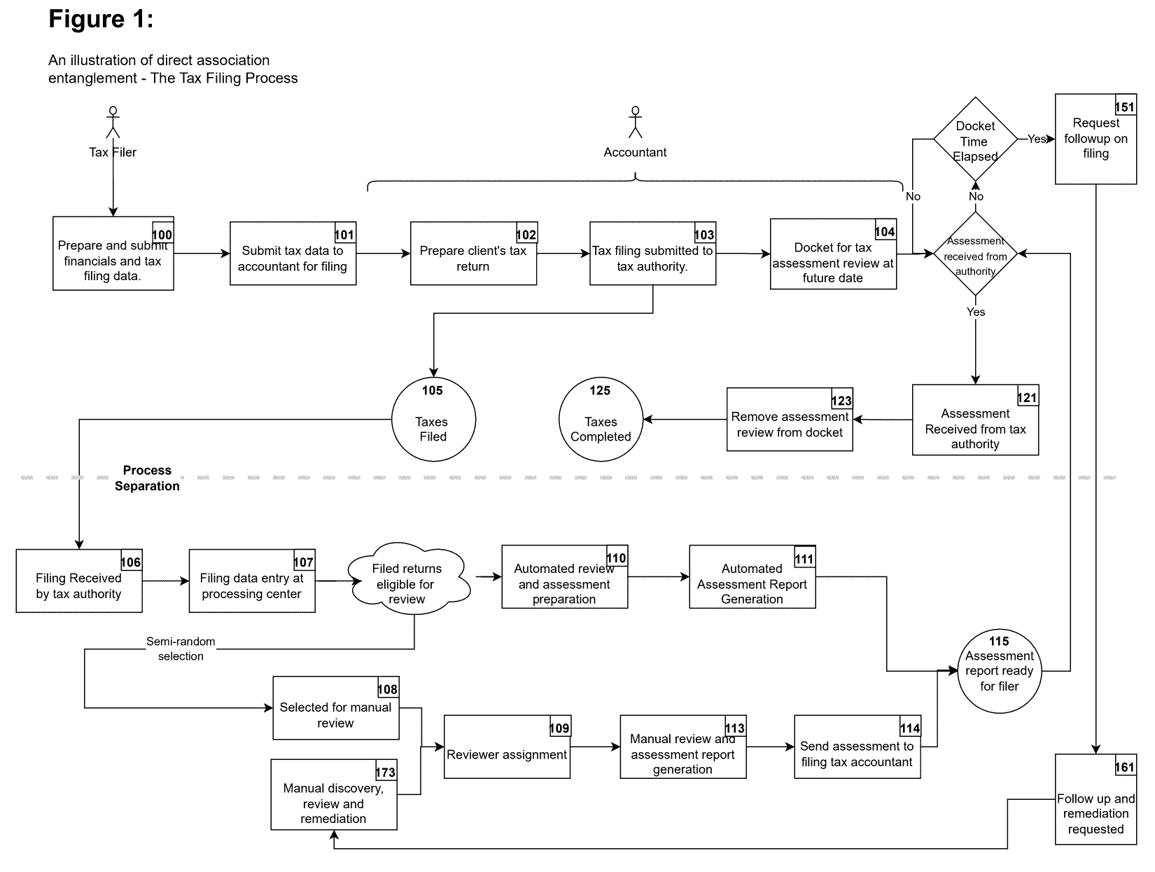

Referring to FIG. 1, shown is a simplified flow diagram of the tax filing process set out above, but in more detail. A tax filer provides income information to their accountant at 101. The accountant at 102 prepares a tax return based on the information provided. The tax return is submitted to the tax authority at 103. At 104, the accountant dockets a file to verify that an assessment for the tax return was received on or before a particular date. At this point, the file is filed at 105 and the accountant moves on to other work.

At 106, the tax authority receives the tax return and sends it to the correct department. At 107, digital data relating to the tax return submission is entered into a computer system of the tax authority; this allows interdepartmental communication of the tax return without physically moving the tax submission. At 108, the tax return is randomly selected for review/assessment and is, at 109, passed onto a tax return reviewer. Alternatively, the tax return is not selected for further review and the numbers entered are verified by software and an assessment report is automatically generated reflecting those numbers or a software corrected version of those numbers, for example with mathematical errors corrected. The reviewer at 111 reviews the tax return and issues a tax assessment report at 113; for example, the tax return is reviewed to make sure certain entries appear to be legitimate and claimable. A tax assessment report is a result of the review. The tax assessment report is then provided to the mail room from which it is sent to the accountant at 115. The accountant receives the tax assessment report at 121 and removes the docket at 123.

As is noted in the diagram, many errors can occur along the timeline, but most are caught by processes or people involved. For example, if the accountant forgets to remove the docket at 123, then the docket-date arrives and the accountant notes that the assessment report is already received. If the assessment report is never received at 121, then the docket-date arrives and the accountant at 151 contacts the tax authority to indicate that no assessment report was received: the accountant re-dockets the expected tax assessment report. At 173, the tax authority initiates a manual remediation of the issue, failure to receive an assessment, resulting in sending the assessment report to the accountant. The tax authority, when they have not prepared an assessment report in accordance with their internal processes, is reminded by the accountant's inquiry of the missing assessment report and then restarts the review process to complete the assessment report at 161. Thus, any number of failures in communication or of an individual are remediated, in time, through the simple process shown.

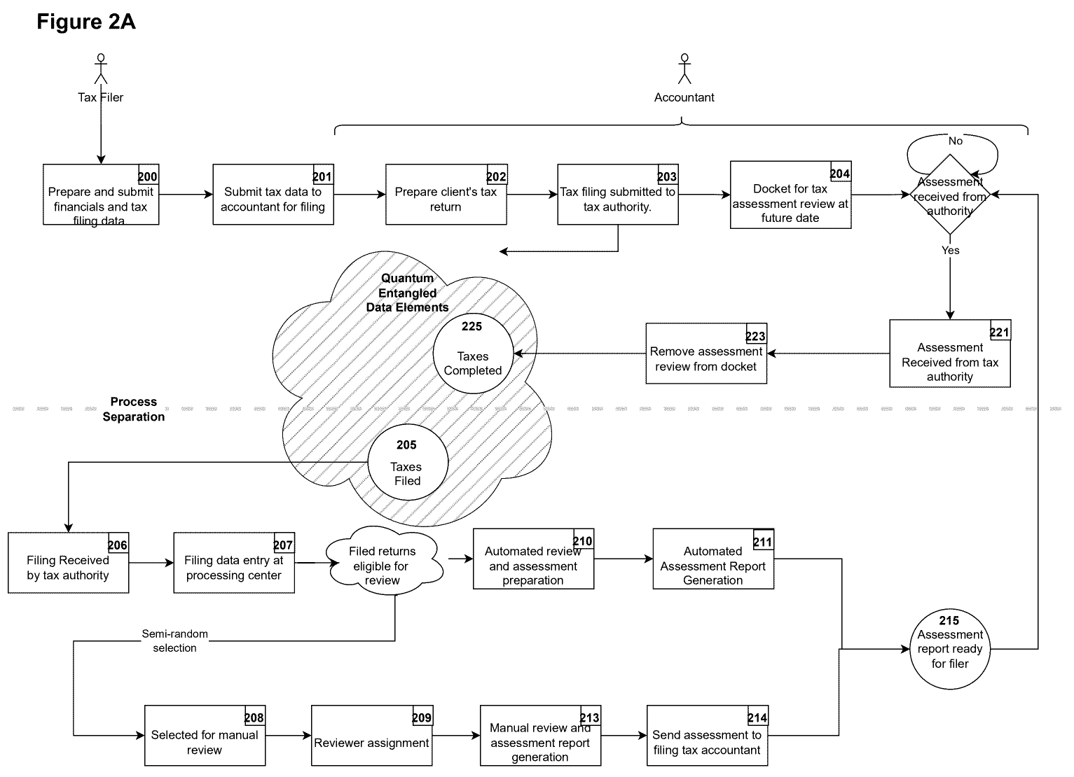

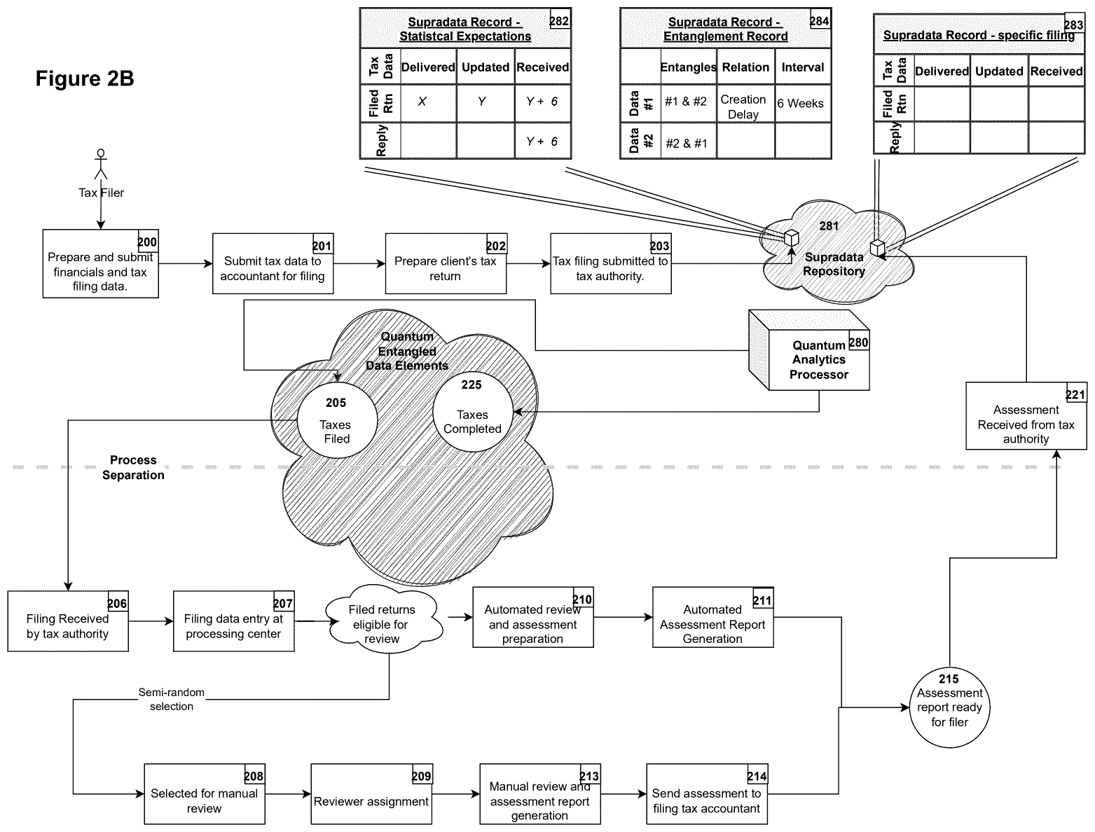

Referring to FIG. 2a, shown is the same method as that of FIG. 1 with an illustration on where data entanglements occur between the separate processes of the accountant and the tax authority. These entanglements can be determined as outlined below. The result of this entanglement pairing will be added to the supradata repository, enhancing the context of both the accountant's and authority's data sets with the contextual records of the entanglement. Optionally, statistical information derived from the entanglements is also updated. For example, an average time to receive an assessment, an average time to transmit an assessment, a minimum time and a maximum time for assessments without errors in the workflow are all added to the supradata repository. This allows the accountant to docket verifying the assessment to some reasonable time based on actual IRS statistics. Advantageously, this does not require the IRS to share confidential information.

Since entanglements are being determined, the entanglements themselves can also act as defining standards for the statistical data. For example, the times for an assessment are provided for business returns and for personal returns, or for the type of return submitted, for the geographic area of the filer, for specific line items in returns, etc. Without disclosing any confidential information, the IRS could immediately reply to a filing with the average and min/max for that exact type of return, however they define it.

Referring to FIG. 2b, shown is a method where the data entanglements and data analytics are used to create a more efficient and robust solution with the whole greater than the sum of its parts. The method is based on the traditional approach shown in FIG. 1 but with a proactive quantum analytics processor, at 280, in execution of a first process for monitoring and predicting method status based on the shared context in the data repository at 281. Such a first process allows for near-real-time access to method malfunctions and remediation based on the context in the repository. Here, a first process is executed to analyse and determine entanglements between events. At the accountant's office, each past tax filing was followed by an assessment report at approximately same intervals for similar returns, in this case, around 6 weeks, as captured in 282. Thus, the system learns that approximately 6 weeks after a personal tax return is filed, a message with a tax assessment report is received: the accountant filing date and the tax authority's assessment report are recorded as being entangled with a 6-week delta plus or minus some variance, at 284, in the repository. This is the primary entanglement with a direct association.

In some embodiments, the first process uses a statistical determination of timing to provide an expected range of time for normal results—direct associations—and a second range for abnormal but acceptable results—indirect associations—and a third range requiring follow-up (dissociations). Each of these associations would be captured in supradata records, expanding on 282, become paths of context, at 284 within the repository 281. The existence of these paths in the repository and the utilization of them enables the real time detection and remediation by this first process as it can recalculate expectations each time it is executed, moving tax filings from waiting for an assessment report, to warning, to urgent/problem requiring follow-up along the way.

Similarly, the IRS executes a process that tells them that tax assessment reports are typically completed within 5 weeks. The IRS system escalates tax assessment reports when they go over 5 weeks, first with a gentle reminder and then with intervention if they are delayed beyond 6.5 weeks. Some tax assessments are more detailed than others and for those, the entanglements are both more plentiful and differently scheduled. Thus, a tax assessment process that is computer-based might enter a schedule where the report is expected to be mailed within 2 weeks, a manual tax assessment might have a schedule with mailing expectation at 5 weeks and manual “problem” assessment might have a schedule with mailing expectation at 12 weeks.

In the third situation, a careful review of the automatically extracted process might warrant a warning letter be sent to the accountant at 5 weeks indicating that the tax filing was flagged for a “problem.” Alternatively, the accountant is provided time estimates and corrections on an ongoing basis.

As is evident from the review of FIGS. 2a and 2b, entanglements can be numerous and can be dependent on pre-conditions and post-conditions. Further, entanglements can be informative, even when expected, as they indicate a potential relationship between events or parties. As such, the automated process for analysis provides significant information. Further, though not shown, entanglements can also support information retrieval from other systems or be based on information retrieved from other systems.

FIGS. 1 and 2 are based on simplified exemplary circumstances to support comprehension. The virtual contextual paths created by the entanglements simplify ongoing insights and their subsequent actions, which makes for a smoother, more efficient, and robust system than the original. In less simple examples, the complexities and breadth of variables introduced by reality may require a multiplicity of the analytics processors. However, due to the resultant entanglement contexts in the supradata, they will all be capable of working in parallel and in conjunction with one another at scale to achieve the same enhanced result.

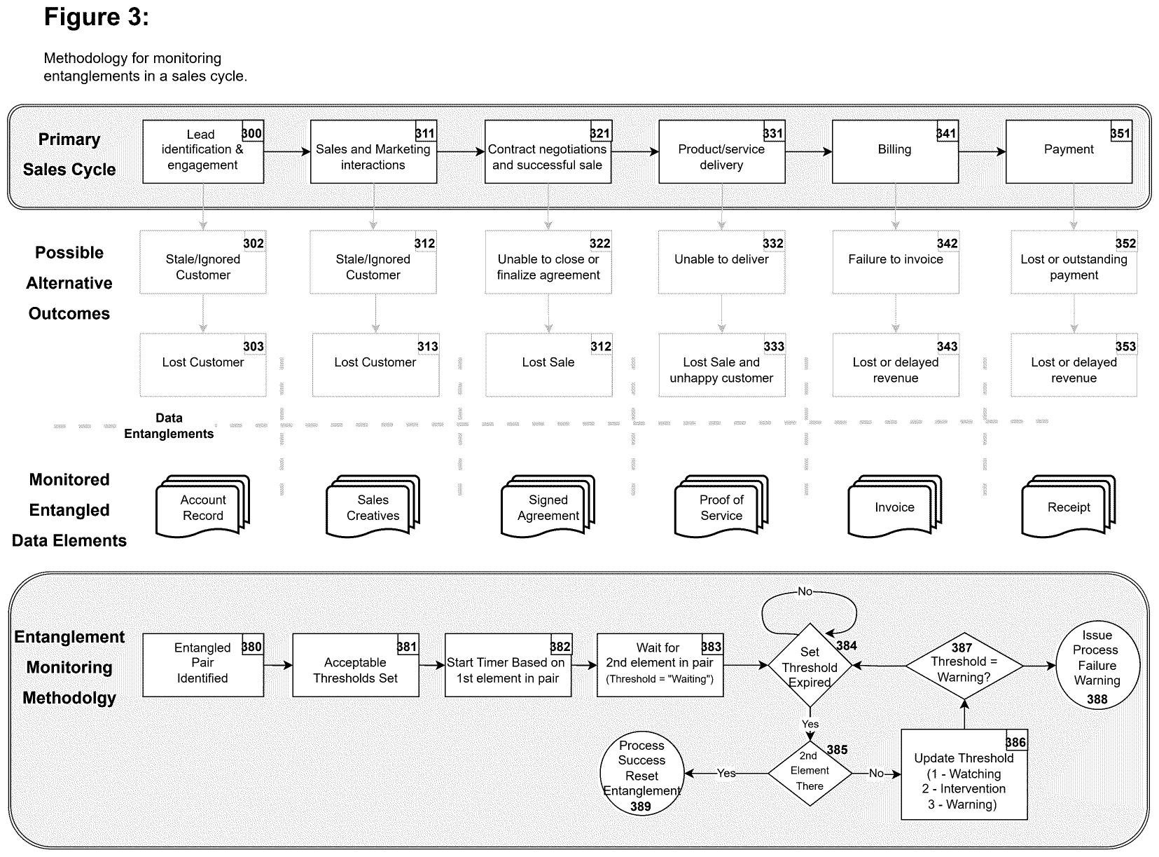

Referring to FIG. 3, shown is a simplified flow diagram of a method of monitoring entanglements in a sales cycle. The primary sales cycle shown begins at 300 with lead-contact and moves forward to a plurality of different endpoints. The success path progresses through 311, 321, 331, and so on to 351. Endpoints other than those are possible, as shown, but have not historically occurred. Thus, it is evident that events 311, 321, and 331 are each followed by another event in normal operation and succession.

A parallel methodology is followed to track the progress and behavior of the primary cycle flow from the perspective of entangled data pairs. In this direct association cycle the pairings are straightforward and, for simplicity, shown as somewhat serial. An Account Record is created before an account is tracked, starting at 300. It is likely that the account will be presented with sales and marketing materials, the Sales Creatives, early in the engagement, at 311, before working through to the Signed Agreement(s) at 321 to acquire the service/product. However, the sales and marketing materials—Sales Creatives—are sometimes optional, where the customer already knows what they want and are ready to go immediately to the contract stage. The pairings essentially become “Account Record” with “Sales Creatives”, and “Sales Creatives” with “Signed Agreements”, and so on through “Proof of Service”, ending with “Invoices” paired with “Receipts”. Each of these pairings have a direct association entanglement. With creation or update of the first element of the entangled data pair, the second is expected to occur during normal sales cycle progression in a well understood, tracked and averaged time frame. For example, with “Proof of Service” resulting from 331, the “Invoice” would be expected to be generated at 341 within an interval consistent with the terms of the contract, as would the subsequent payment by the customer, at 351, resulting in the “Receipt.” This progression of entanglement pairs enables a mechanism for the tracking and monitoring of the sales cycle process. The Entangle Monitoring Methodology, which begins at 380, illustrates the process.

The entanglement methodology also allows for the detection or prediction of the anomalous alternative path outcomes and other endpoints. An absence of the next element in a given entangled pair as may be caused by an event such as at 302, 312, or 322 identified as a potential omission and leads to escalation of said branch, first to a “watch” state and then to an “intervene” state. Thus, each of events 311, 321, and 331 are simply intermediate events and require further events to reach an end of the process. By determining entanglement at 311, based on “Sales Creatives” with “Signed Agreement” from 321, the system identifies events 311 absent 321 therewith and flags these as potentially incomplete processes leading to 312 and 313. The identification of entangled data in this example allows for identification of missing documents or extracted fields from within the data. In this manner quantum data entanglement and analytics enhances robustness in the data collection, storage and communication processes.

A very similar methodology is also applied for indirect data entanglement pairings. The accuracy and efficacy of the predictive model in such cases will be moderated by the degree of entanglement, the known tolerances of entanglements, and a cost associated with error.

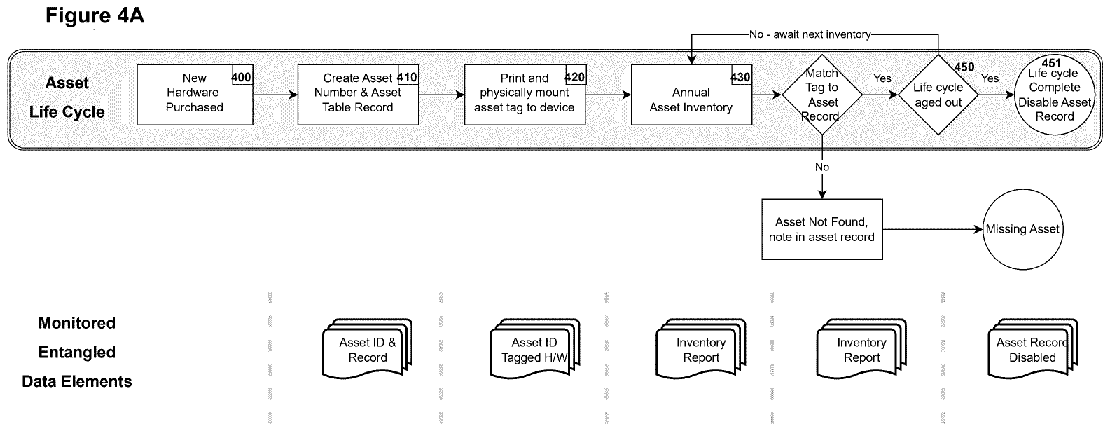

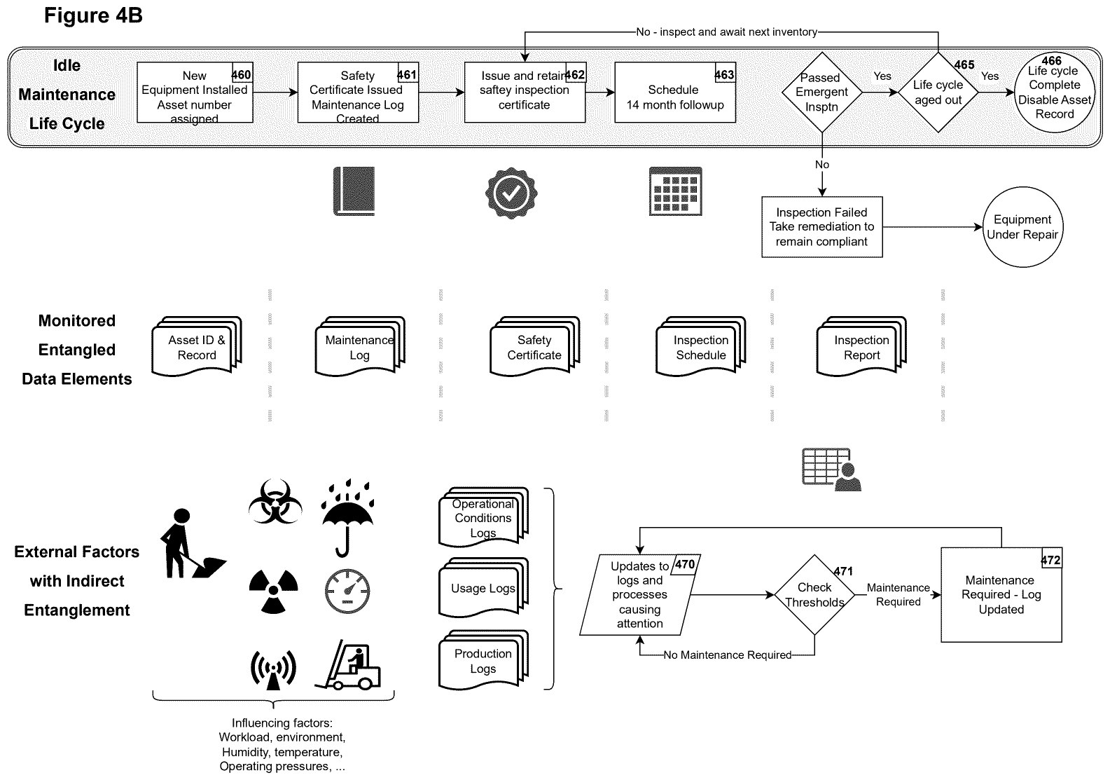

Referring to FIG. 4a, shown is another example of direct entanglement. Here, a purchase of an asset leads to an asset tag within a company's portfolio of asset tags for each of the company's assets. Purchase of a computer, at 400, is followed by an asset number allocation, an asset-table entry creation, at 410, and asset-tag printing. The asset lifecycle then follows a predictable path, for a computer it is verified in asset-inventory reports, at 430, annually for three years and then replaced with a newer computer. The old computer is then discarded in accordance with company policy, at 450, the asset tag is destroyed, and the asset-record is set to retired, at 451. The asset table entry—asset record—is directly entangled with the asset tag, which is in-turn directly associated with the physical device. Each of the events in the asset tag lifecycle are expected and predictable, given the asset purchase of a computer. From an entangled pair perspective, the asset record and the asset tag, as reflected in the inventory report, are bound with a recurring one-year interval. Thus, an absence of the second element of the matched entangled pair, for example the asset tag/computer not showing up in the annual inventory after one year, is an anomaly.

In some cases, for example with manufacturing equipment, the events over time are more complex and more interdependent resulting in complex multiple entanglements with complex outcomes for non-compliance.

For example, referring to FIG. 4b, a piece of manufacturing equipment typically needs service every 14 months for safety compliance. That said, manufacturing is 24 hours a day 7 days a week for 11 months out of the year. Servicing the equipment requires three days, based on the prescribed maintenance process. Therefore, waiting until 14 months to service the equipment will result in 3 days during which manufacturing will be stopped. With different maintenance schedules on different equipment, this results in many “down” days for the manufacturing schedule. This scheduling challenge reflects a complex but straightforward set of direct entanglement pairings, the original inspection certificate for each device with its next certificate at a known set of intervals. When a service requirement is based on another service requirement, and so forth, the complexity of scheduling and of servicing the equipment only grows. The model as described, is an over-simplification of the real-world process.

In many manufacturing scenarios, safety and security maintenance is not based solely on time, as tracked by the idle maintenance schedule, but also on usage and operating environment. Not unlike the components of an automobile, which must be maintained or replaced based on how far the vehicle has been driven, in the case of the manufacturing equipment, the maintenance may be tied to any combination of a number of factors, such as the number of units manufactured, the volume of waste product produced during manufacturing, for example, the amount of shavings in the air or perhaps even the average operating temperature while the machine is running. These are tracked in various and sundry logs, at 470, which are indirectly data entangled to the maintenance log and the safety certificates, both of the manufacturing equipment and related or other manufacturing equipment. These variables would have their own criteria on how they would impact any need for maintenance, as evaluated at 471. Only if the operational, environmental, and other external criteria exceed their individual thresholds would this result in direct maintenance. The logs and readings that monitor these criteria along with their respective acceptance thresholds form data elements that are indirectly entangled with time-based maintenance logs and the safety certificates. Each adds their own complexity to the mix, which may or may not impact the originally required date. When one of the indirectly paired criteria crosses its threshold value, its entanglement pairing to the time-based/idle maintenance schedule is triggered. A pre-emptive maintenance event results, the idle schedule is reset and, potentially, all of the other entangled threshold criteria are reset as well.

Similarly, the indirect data entanglement and subsequent pairing with the maintenance log and security certificates allows for an adjusted schedule where factors were impacting the idle machine capabilities but were not collectively exceeding their thresholds to trigger direct updates on the maintenance log and schedule. Indirect pairings also occur between different equipment. For example, if one system is being disassembled for maintenance, that may open up access to another system or provide downtime of another system for maintenance. Sometimes, maintaining systems more often than needed is more cost effective if they are maintained when already not operational. Thus, wear on a first piece of equipment sometimes indirectly affects the maintenance schedule of another piece of equipment.

An analysis of the entangled scheduling requirements allows a process to predictably be mapped and to be manageable and changeable, while changing interdependencies. With human issues added to the mix, the scheduling and changing of schedules is simplified through automated entanglement analysis and prediction. Once again, when maintaining one piece of equipment indirectly affects maintaining a second other piece of equipment, all dependencies are available for scheduling and for rescheduling purposes.

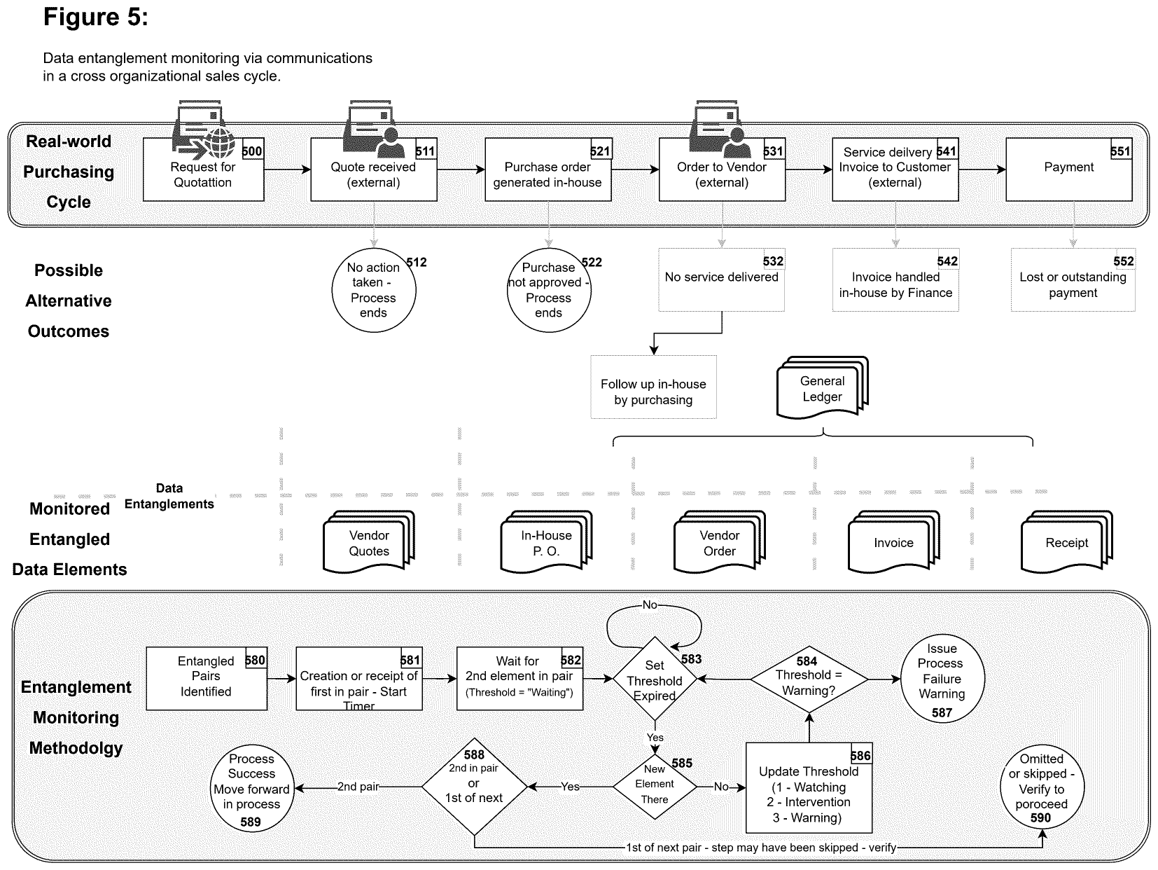

Referring to FIG. 5, shown is a complex communication system process for monitoring entanglement. Here, an RFQ (request for quotes) is sent out to one or more suppliers via email at 500. At 511 one or more emails, each with a quotation, is received. It is normally followed by an in-house purchase order at 521, an order to the vendor/supplier via email at 531, delivery of the service and invoicing for it at 541, and a cheque generated for payment, at 551. Along the way suitable accounting entries are managed in the general and appropriate subledgers; delivery schedules, delivery, installation, etc. are all managed as a part of the real-world purchasing process. However, the quote can be followed by nothing—no action, no order etc., at 512. This is a perfectly valid state, though undesirable; preferably, those items not followed have an end point within a process such as a terminate this quote option. When more than one quote is provided for a same effort, then accepting one typically will terminate all other quotes. Though it is ideal that each respondent to the RFP is notified of the result, often only the winner of the contract is informed.

When followed by a purchase order, however, the quote turns into a purchase and all the requisite follow-on entries, orders, scheduling, communications, processes, etc. are expected. Therefore, from an accepted quote onward there is a business process in progress and its progress has both direct and indirect data entanglements through different systems including emails and other forms of communication and the general and sub-ledgers. The business process is also tracked by the existence, or creation of supporting and enabling documents, such as the P.O. (purchase order), the vendor order agreement, invoice, and receipt. Many of these data elements exist in-house in the financial system but some may not. These processes are managed internally to the organisation. However, some are either sourced or resident externally, such as the vendor invoice. Such documents are often mailed in the traditional manner, shipped physically attached, included with delivery or sent electronically, directly or through email. The process optionally extends across numerous organisations to determine cross-organisational events and the entanglements managed across data elements which are resident in the ERP systems, emails, or on physical documents and devices. The entangled pairings they reflect with the ledger are such that the entire overall process is manageable, either manually or explicitly automatically.

The process, as outlined from 580 through 590 tracks these cross-organizational pairings and allows for step-by-step progression in the process. When a step in the process or an ancillary event—an entangled but seemingly unrelated event—is absent, this flags a remediation process. For example, the absence is examined or evaluated. Sometimes, there may be exceptions. That said, typically, absence of an entangled data element or event signals an issue to be monitored or to be addressed.

For example, when three quotes are requested for a same task, acceptance of one terminates the other two quotes. The termination of the quotes, when paired with the quoting party results in the quotes being terminated by the quoting party as well. Alternatively, unterminated quotes are docketed for follow up. Thus, due to the entanglement, unnecessary follow-ups are fewer and processes are more optimised. When performing a large contracting process with hundreds of quotes, entanglement can streamline the process to limit omissions, enhance communication, and optimise the overall quoting communication process.

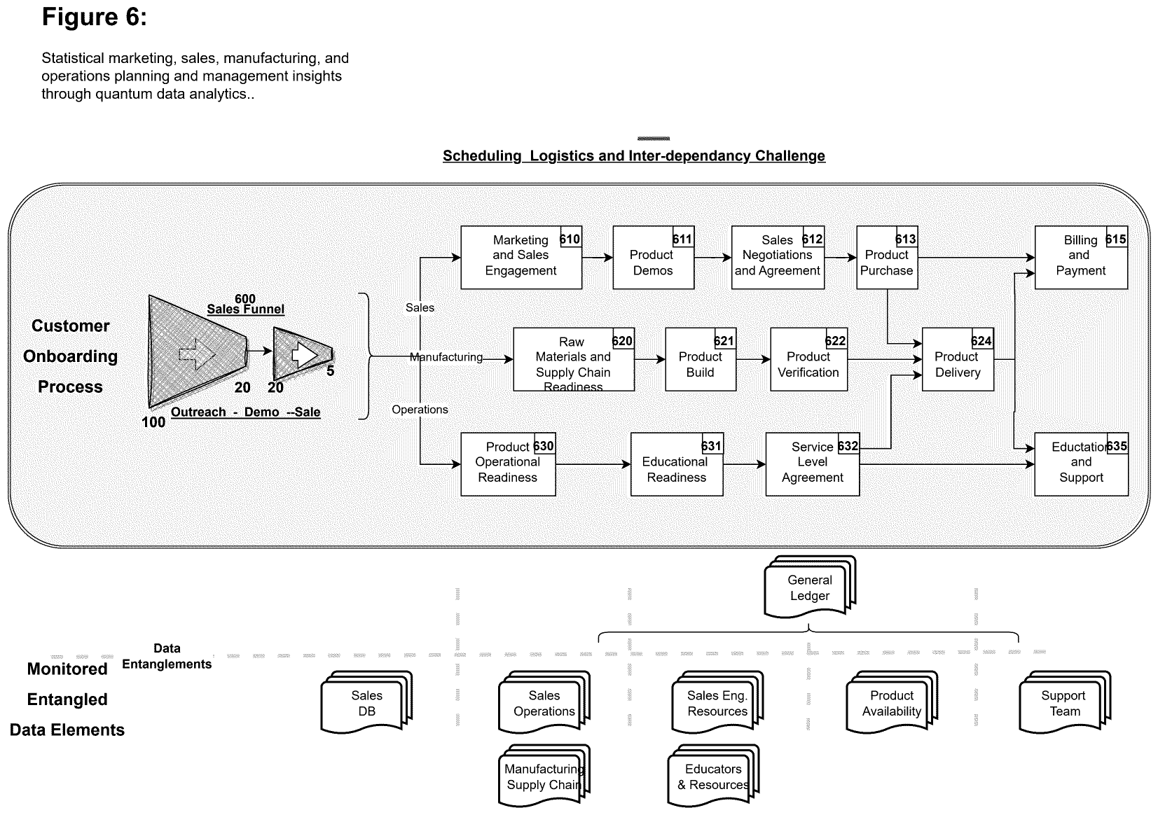

Referring to FIG. 6, shown is a simplified sales process and how it impacts and interacts with multiple independent internal and external company processes. Company X begins a sales process. The sales process commences with reaching out to a potential customer market. As represented by the sales funnel at 600, company X already estimates that for every 100 contacts with potential customers, 20 will result in demos and 5 will close as sales. These two projected scales have impact not just on the sales team but also on manufacturing and operations. In the sales flow, starting at 610, this means that with 100 contacts, time, resources, and availability slots for 20 demos need to be arranged, as per 611. It would be problematic scheduling follow-up without sufficient allocated demonstrators—people and equipment. There also needs to be the legal, contractual, and finance team support to complete the 5 sales, as represented by 612 through 615.

Similarly, for every 100 contacts, supply chain sourcing and orders of parts for 5 products are needed by manufacturing, at 620 in a timely enough manner to support finished product delivery at 624. Also, the operations and support teams need to be ready to support the product going into the field, at 630, including the resources and abilities to educate the customer at 631 and provide the agreed upon level of service from a support perspective, at 632 before the product is delivered.

As illustrated, these multiple “independent” processes are impactful on each other. And they are not necessarily serial in nature with each event following after the others. Many activities must progress in parallel or even precede other events. If the sales team makes 100 contacts, the system itself sees the entanglement of 20 demonstrations involving people and equipment and 5 sales involving product, delivery, training, etc. Also, the system recognises that product purchases require purchase orders, financing, etc. and sales requires people to close each sale. Here, sales also involve negotiation, legal, and management approval. Manufacture includes order, delivery, storage, inventory costs, packaging, testing, etc. Delivery includes installation, training, etc. Though these are all independently scheduled, they are inter-related. No one wants training on their new equipment before it is installed. Few want training a long time after installation. The timing of inter-related events is important. Limitations such as shipping receiving space and straffing limit growth. Similarly, the approvals/contracts happen in temporal relation, often in a set order with tight timing.

Now, these processes exist and are typically followed quite closely. In some organizations project managers are assigned to keep these factors in line. However, that does not scale well as the sales jump from 100 to 1,000 to 1,000,000. Even in the 100-customer volume, what happens if someone on a team drops “the ball.” What if the new assistant in operations fails to schedule training. This becomes evident a few weeks after delivery when customers are calling asking how to use their equipment. Sometimes the delay between purchase order and training can be months and a sudden discovery of failure can result in a major scheduling problem at the seller's end. For example, there might be three training sessions each day for months, all booked in advance. Squeezing in 30 new customers for training is a major problem; there may not even be space in the schedule to squeeze in one new customer for training. Finding new training options is often prohibitive. The problem was unknowingly created months before it was even noticed.

Now, turning to the present process, entanglement of operations' scheduling and sales is noted in analysis. Now, when sales goes ahead and training is not scheduled, the lack of training scheduling is escalated to a warning—tell someone to schedule training—as it should be present. Then, if still not addressed, the lack of training scheduling is escalated to an urgent matter. Someone senior needs to waive the scheduling of training or else the process and its entanglements all need to be present.

In small to medium size businesses, many processes just happen. As the businesses grow, the processes change unintentionally and often problematically—good or bad. For example, hiring a new sales manager who moves sales from 5 per hundred contacts to 10 per hundred contacts seems good, from a sales perspective, but causes issues with manufacturing and training. Using the present process, the events and their entangled data are highlighted when a process is changed, either intentionally or inadvertently, allowing management to decide what is essential to the process and what is optional. Management can waive optional process steps while maintaining essential ones. Management can change scheduling and see the effects on entangled concerns. Further, new staff have difficulties eliminating process steps without approval because management is notified of any absent entangled steps.

By notifying management of missing entangled elements, upcoming entangled deadlines, or changes to entangled relationships, the process improves repeatability of business processes and statistical evaluation thereof. Also, during periods of growth and decline, entangled processes are manageable to grow or shrink as is required by the changes in the overall enterprise. For example, during a period of growth, loading dock space is planned to grow ahead of need such that it does not impede growth. This is very significant, for example, when loading dock space is regulated—bonded or for hazardous chemicals—such that the process of expansion requires long lead times.

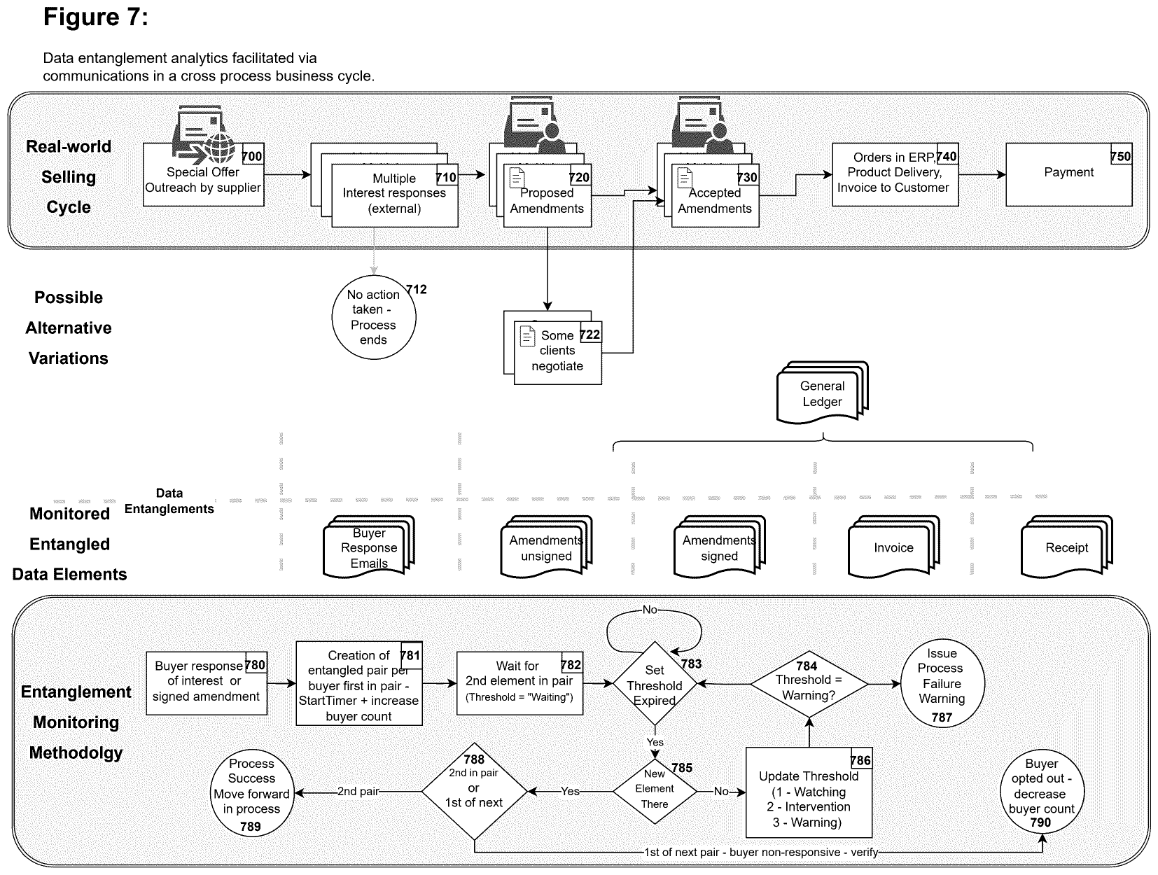

Referring to FIG. 7, shown is a method of email communication evaluation for use in monitoring data entanglement and benefiting through quantum data analytics. Email is by its nature a decoupled, disjoint system for asynchronous communication. As such, it is well suited to having quantum data entanglement analyses, both direct and indirect. It is a facilitating factor where the processes which are linked by the data entanglement are separate, whether by geography, organization, system, department, function, time, or any other disjoining circumstances. Such entanglement is useful to detect, manage, and monitor disjoint systems that benefit from co-ordination based on actionable insights of quantum data analytics. Coordination is sometimes performed in a co-ordinated fashion and other times is merely a result of changes in each organisation to result in more coordinated effort or process.

Consider the simple case where a supplier and a buyer, already in an active business relationship wish to make some temporary amendments. For example, the supplier of a salty snack food is trying to increase sales volume. In support of this they reach out to their buyer contacts with premium retailer customers offering a price cut in exchange for committed sales volumes. Several of the buyers express an interest in the deal. The supplier sends out amendments to the original contracts to each of them through email. They acknowledge and accept the deal returning signed versions of the amendments. Each of these communication cycles are occurring in parallel. In this example, there are multiple disjoint parallel processes which are independent of one another. However, from the supplier's perspective, they need to be tracked and managed each with the level of attention as if the buyer were their only customer. The impact of not performing this task successfully or too slowly is lost business and potentially a lost customer.

Similarly, when the supplier also sells beverages, a simultaneous offer by both the salty snack and the beverage department results in coordinated effort when both are accepted. Shipping and receiving now ships the minimum volumes each month of each product group.

Now consider this challenge as illustrated in FIG. 7. At 700 the supplier initiates the selling opportunity by communicating their offer to their key customers via email or some other alternative social media channel through which they know they can reach their customers and perhaps the broader market. At 710, the process becomes parallelized as a multiplicity of customers reply indicating interest. This is the first opportunity for an entangled pairing across the communication medium of choice. Those customers who replied indicating interest in the business opportunity each start off a parallel track from the supplier's perspective. As such it is important that the supplier ensures a packet is sent to each customer who expressed interest with the details and for simplicity, the actual proposed agreement as amendment for each customer. There are two possible pairings here, the inbound message from an external customer indicating their interest with the outbound message, sourced from the buyer's organization, at 720 with the details. Or the inbound interest message with the corresponding personalized amendment possibly, as illustrated, as an attachment. Similarly, if the customer chooses to optimize their position and negotiate, through the path at 722, there would be a pairing tracked series of communications culminating in an agreement amendment which is acceptable to both parties. Whether through 722 or direct from 720, at 730 the buyer receives the external message of acceptance with the entangled data element of the signed amendment. This data element should be the balance to the unsigned amendment from 720. It also serves as the first element of a pairing with the enterprise resource planning (ERP) system, balanced by updating of agreed pricing and terms as reflected in the signed amendment. Similarly, there are pairings created with the accepted amendment which should balance product delivery and invoicing at 740 and ensuring a matching payment at 750. These pairings align the GL (general ledger) entries with the amended details as the actual transactions proceed.

The methodology by which these external communication-based pairings are tracked, perhaps by a separate processor, begins at 780. The method outlines the tracking of two pairings, the external indication of interest to the signed amendment and the signed amendment to the updated GL reflecting the full invoice and payment transactions. In many cases, the data entangled pairings are the existence of the documents, e.g., the outbound attachment that is a proposal and the inbound attachment that is a signed amendment. In this manner, the quantum data analytics need only monitor the metadata where such documents are stored or transited, either the repository where they are kept or the medium by which they are communicated, i.e., email. Both methodologies follow this similar path. And not without limitation, many other quantum-entangled data elements follow this path as well.

Besides tracking and tracing the success path, this methodology provides value by providing a detection of and application for the remediation of issues within the sales process. By establishing and tracking acceptable thresholds, such as elapsed time, between the detection of the existence of the paired data elements at 782, the supplier ensures that for each parallel process and each customer, attention is given to finalise the amendment and execute the business transaction. None of the parallel flows falls by the wayside or is forgotten. However, the remediation flow does allow for the customer to opt out if no agreed upon terms are achieved, as illustrated at 790. Therefore, just as in the introductory example, the data entanglement and its supplemental monitoring process can prove the negative where nothing has been done. And in the case of missed business opportunities take corrective action.

Similarly, the same entanglement analytics as apply to emails also apply to directed messaging whether over mobile devices, via simple messaging system (SMS) or texts, or over asynchronous messaging applications such as Slack®, Whatsapp®, Facebook Messenger® and others. These share the characteristics of emails pertaining to decoupled communication with or without attachments. The same entanglement analytics also apply across communication media such that the initial email is followed by text messages and then communication returns to email messages, etc.

Though the examples highlight clear entanglements, advantageously by automatically extracting entanglements, processes are shepherded along based upon past correlations that were found to be meaningful even when not clear or evident. For example, when it is found that a pattern of behaviour in email leads to resignation within three months, noting the pattern triggers a hiring process long in advance of the resignation. Similarly, patterns that indicate hiccups in a sales process allow for more skilled salespeople to intervene earlier in the sales process, either to close the sale or to terminate the sales process and save company time. It is often the unobvious entanglements that lead to significant optimisations.

Referring to FIG. 8a, shown is a system for determining and using data entanglements in process execution and audit. The first process is a model of the predominant and preferred path in a sales cycle flow, as beginning at 800. As this flow proceeds observation of various data sets, at 801, such as the enterprise's corporate financial and ERP (enterprise resource planning) systems, communications, logs and reports generated by process-involved tools, and a broad range of documents provides the source for data elements which are integral to the process flow. They are also related to each other as data entangled pairs, as illustrated at 860. As previously noted, the entangled pairs need not reside in a common repository, they need only be reachable, either directly or available for observation via meta-data. Examples of pairings shown at 860 include, Corporate Budgets to Sales and Marketing Expenditures, Customer Communications to Draft agreements, Draft agreements to accepted and Signed Agreements, Orders to Deliverables, Deliverables to Invoices, Invoices to Receipts. And the last few pairings may also have parallel pairings to transactions in the GL (General Ledger) or its subledgers. With the modeling and observation of the exemplar first sales processes, the data entangled pairs are determined and cataloged.

Referring to FIG. 8b, shown is a simplified flow diagram of a method for monitoring and managing entanglements in process execution and audit. A dataset used during a first process, as determined in FIG. 8a, is analysed to determine common elements forming part of the first process when executed, as illustrated at 880. For example, when the first process is a sales process, emails, messages, phone calls, salesforce® logs, etc. are analysed to determine process execution steps from first contact to closing of a first or subsequent sale. The common elements are mapped within the first process to provide an estimated process flow. The estimated and modeled process flow provides a most likely process flow. Alternatively, the estimated process flow provides all likely process flows including parallel, skipped, and optional elements. The estimated process flow is then stored for later use. It can be considered a baseline for future reference. At any later time, the actual flow in execution can be monitored through its entanglement, as shown at 891, where a record is kept of each process progression instance and reflected through the progression of time with continually updating statistical projections and analytics.

At a later time, for example when an executive seeks to evaluate a specific sales event, the executive compares the sales event against the baseline process flow or the statistical projections model, for example using a mapping tool to map a specific sales process onto the estimated process flow. Immediately, the executive can see where in the process flow the sales event is at present—how close is the company to a sale—and what steps have been missed in the process. For example, if the process has been executed but no one determined the customer budget, then remediation to ascertain a budget is performed to return the sales event to its “natural” process flow. This allows management to prevent sales “hiccups” caused by missed steps. Similarly, comparing a current process to an estimated process provides significant insight into scheduling and revenue planning, as illustrated in the flow beginning at 895. Finally, mapping a present process into an estimated process flow allows for prediction of upcoming events, good or bad, that need to be addressed.

An example of this is good practice vs. best practice, which can be achieved through the analytics methodology at 895. One salesperson has an estimated process flow that is much more efficient than another. Applying the more efficient of the two process flows to everyone, may be a huge benefit to the organisation, but, the most efficient process flow may instead relate to other reasons, for example most sales are to one client. Thus, the entanglement itself is insufficient to always predict best practices but is very useful in optimising practices across an organisation, in auditing practices both after and during execution, and in seeing how a process unfolds for planning and resource allocation. Further some entanglements, once noted, are an excellent source of material for A/B testing. Salesperson A does much better than Salesperson B with a similar process, but Salesperson A sends out birthday cards to the clients. Sending out the birthday cards to Salesperson B's clients is a straightforward testable methodology.

Entanglement can cross datasets, repositories, processes, departments, geographies, etc. For example, processes involving a specific piece of equipment logically could interfere with other processes using the same piece of equipment. Thus, entanglement analysis allows for detecting potential interference. The entanglement could extend to unrelated modifiers. For example, the religion of staff may affect production at certain times of year. The calendar entries of staff, anniversaries, weddings, etc. often affect after hour availability. Cultural and national differences affect performance in certain matters. Thus, the ability to produce a diagram of entanglements is important, not only for predicting failure or element absence, but also for predicting effects of dramatic events. A tornado in Oklahoma affects staff in Oklahoma, but also causes pressure on a series of entangled processes having entanglements in or around Oklahoma. Notifying the system of the tornado warning allows the system to highlight all potential processes affected and therefore to allow management to manage the situation better.

Though the description focuses on logically understood entanglements, this will not always be the case. Rising oil prices might be found to affect employee health—how often employees call in sick. Cold weather might correlate with late production. All this without any evident logical reason. What is determined, however, is that there is a potential correlative link between the entangled events, processes, resources, etc. In fact, an event and a resource might be entangled in some way. Some entanglements are counterintuitive, they seem to be wrong; for example, higher paid employees are sometimes less productive or increased vacation days leads to increased annual efficiency. The more repeated an entanglement, the more reliable it is as a predictive or planning tool. Entanglements found often in local data are reliable locally; Entanglements found often in global data are reliable globally.

Numerous other embodiments may be envisaged without departing from the scope of the invention.

What is claimed is:

1. A method comprising
providing a first process;
providing first data;
analysing the first data within a data store to map second data forming part of the first data to different instances of the first process;
determining first differences between the different instances of the first process;
proposing A/B tests, where some first processes are implemented according to Process A and some first processes are implemented according to Process B, Process B different from Process A, for determining which first difference is statistically controllable through varying the first process during execution between A and B,
when a first difference is statistically controllable, selecting between A and B the process that is a statistically improved version of the first process; and
storing the improved version of the first process as the improved first process.

2. A method according to claim 1 wherein Process B is a process similar to Process A but absent a missing step.

3. A method according to claim 2 comprising:
when a current instance of Process B is detected in execution, providing an indication to a user to add the missing step to current instance.

4. A method according to claim 2 comprising:
when a plurality of instances of Process B are detected, providing an indication to a user to add the missing step to a first group of processes comprising some of the plurality of instances of Process B and to not add the missing step to a second group of processes comprising others of the plurality of instances of Process B different from the instances in the first group; and
comparing an outcome of the first group and the second group; and
when the outcome indicates a statistical likelihood that the missing step affects the outcome of the processes, providing an indication to the user of the statistical affect of the missing step.

5. A method according to claim 4 comprising:
ensuring that the first group and the second group are sufficiently large and diverse to provide statistically relevant results regarding the missing step.

6. A method according to claim 2 comprising:
when a plurality of instances of Process B are detected, providing an indication to a user to add the missing step to a first group of processes comprising some of the plurality of instances of Process B and to not add the missing step to a second group of processes comprising others of the plurality of instances of Process B different from the instances in the first group; and
comparing an outcome of the first group and the second group; and
when the outcome indicates a statistical likelihood that the missing step affects the outcome positively adding the missing step into the first process for future instances thereof.

7. A method according to claim 1 comprising:
maintaining most variables same between Process A and Process B.

8. A method according to claim 1 comprising:
maintaining all variables other than the missing step approximately same between Process A and Process B.

9. A method according to claim 1 comprising: prioritising a first test between a first Process A and a first Process B over a second test between a second Process A and a second Process B.

10. A method according to claim 9 comprising:
when the first Process A and the first Process B achieve similar results, deprioritising the first test relative to the second test.

11. A method comprising:
analysing at least a data set to extract therefrom data related to a first instance of a first process for achieving a first result;
analysing the at least a data set to extract therefrom data related to a second instance of the first process for achieving the first result;
determining common elements of the first instance of the first process and second instance of the first process;
mapping the common elements within the first processes to provide an estimated common process flow including potential causal links;
determining a potential causal link for exploration, the causal link related to elements within the first instance of the first process that are not common to elements within the second instance of the first process wherein the first instance and the second instance have statistically different results;
performing a test to see if the potential causal link is statistically causal; and
when causal, including the potential causal link within the process as a causal link.

12. A method according to claim 11 wherein determining that the first instance and the second instance have statistically different results is performed by performing the test.

13. A method according to claim 11 wherein determining that the first instance and the second instance have statistically different results is performed by performing a test of results achieved with the elements that are not common included in the first process compared to results achieved absent the elements relative to each other and to an expected result.

14. A method according to claim 11 wherein determining that the first instance and the second instance have statistically different results is performed by performing a test of results achieved with the elements that are not common included in the first process compared to results achieved absent the elements relative to each other.

15. A method according to claim 11 wherein the results relate to a financial outcome.

16. A method according to claim 11 wherein the results relate to a risk associated with the process.

17. A method comprising:
analysing at least a data set to extract therefrom data related to a first instance of a first process for achieving a first result;
analysing the at least a data set to extract therefrom data related to a second instance of the first process for achieving the first result;
determining common elements of the first instance of the first process and second instance of the first process;
mapping the common elements within the first processes to provide an estimated common process flow including potential causal links;
determining a potential causal link for exploration, the causal link related to a first element within the first instance of the first process that is not common to a second element within the second instance of the first process;
performing a test to see if the potential causal link is statistically causal of a difference in outcome between the first instance and the second instance by performing some processes with the first element and other first processes with the second element and comparing results obtained with the first element against results obtained with the second element; and
when causal, including the potential causal link within the first process as a causal link with an indication of which of the first element and the second element is preferred.
